(19) United States
(12) Patent Application Publication
(10) Pub. No.: US 2011/0253045 A1
(43) Pub. Date: Oct. 20, 2011

(54) Sheet material laminating machine for the plastic lamination of paper or similar materials using the application of a liquid polymer coating and its curing via ultraviolet light sources

(76) Inventors: Beverly Bensen, Fox Lake, IL (US); David Feider, Fox Lake, IL (US)

(21) Appl. No.: 12/917,480

(22) Filed: Nov. 2, 2010

Related U.S. Application Data
(60) Provisional application No. 61/257,478, filed on Nov. 3, 2009.

(51) Int. Cl. B05B 15/00; B05B 1/00

(52) U.S. Cl. 118/668

(57) ABSTRACT

A plastic-laminating machine for the coating of paper or similar materials with a plastic coating and only to the exact dimensions of the paper eliminating the need for trimming and offering the option to laminate on one side of the material or on both sides.

The inventive elements combine to create a Liquid Laminating Machine which will not only deliver beautifully laminated sheets but do so without the drawbacks of existing laminating machines on the market. The present invention offers economy, low supervision and maintenance, low-energy operation, low toxicity due to elimination of VOCs and elimination of the labor and waste of trimming the laminated materials.

### RELATED APPLICATIONS

This application claims the benefit of U.S. Provisional Application No. 61/257,478 filed Nov. 3, 2009.

### FIELD OF THE INVENTION

This invention relates to office equipment typically used to laminate paper of various sizes with a plastic coating for its protection and improved quality as presentation material. Most existing machines of this type utilize plastic film dispensed from a roll or a plastic pouch for the insertion of a single sheet. The present invention coats the substrate with a liquid polymer then sets or cures the coating using a unique dual-element ultraviolet curing system.

### DISCUSSION OF PRIOR ART

It is our assumption that prior art will show that the present invention is unique in its method of handling the paper, automatic scanning of the inserted material for the precise application of polymer laminate without waste, application of the coating, the polymer chemical composition and operator-selectable coating thickness.

In reference to U.S. Pat. No. 6,143,370; the polymer coating is achieved using a two-part mixture of a base polymer and a catalyst for curing. The machine applies both elements to the substrate directly or they are pre-mixed internally before application. The present invention shall cure the polymer after application by its subjection to ultraviolet light.

We reference U.S. Pat. No. 5,239,018 to show a coating developed for the purpose of applying a clear coating to various materials. The liquid polymer as it is described does not need a catalyst added for curing but contains volatile organic compounds. In the current regulatory trend for lower VOC emissions and high-solid type polymers the polymer referenced in U.S. Pat. No. 5,239,018 is not a good consumer choice. The present invention shall utilize a liquid polymer not needing a catalyst, having no VOCs and is 100% solids.

U.S. Pat. No. 5,232,538 covers an invention using a thermal energy source for the melting of a clear-drying adhesive for the lamination of the substrate. The need for a heat source is eliminated in the present invention therefore reducing energy consumed by the machine.

Finally prior art of a similar invention may be seen in U.S. Pat. No. 5,421,947. The inventor describes the machine's laminated substrate as having ‘pristine edges’. Upon close examination of the methodology used in transporting the finished product the machine is subject to jamming as is typical of film laminators.

### BACKGROUND OF THE INVENTION

The present invention overcomes four problems associated with prior art: (1) The need to combine the polymer with a catalyst prior to its application (2) The emissions inherent in the use of substances containing volatile organic compounds (3) Heat processes for adhesion of the laminate to the substrate and (4) The marring of the laminate surface after coating or wrinkling of the substrate in the process of its conveyance through the machine.

Key features of the present invention are automatic operation, the elimination of the need to manually trim laminated sheets and the process of removing spend film laminate rolls and re-feeding the new roll of film through the machine. Pouch-type laminating machines require manual insertion of the material to be sealed into a plastic pouch and typically manually feeding the materials into the laminating machine. The present invention automatically adjusts its internal settings to the size of paper or other material for lamination, a user interface sets the thickness of the desired coating and the laminated product is ready for use within two minutes. The present invention, by applying a liquid polymer to the edges of the substrate and curing same with UV light sources eliminates the trimming required of pouch or roll-film laminate material. Pouch and roll laminating machines thermally set the plastic coating with at least 20% waste material for trimming. Pouch-type laminators accept a selection of pouch sizes but roll-type laminators are limited to their design roll width.

### BRIEF DESCRIPTION OF THE DRAWINGS

FIG. 1 is a perspective view of invention depicting the following items:

The substrate; material to be laminated, 1, micro-positioning piezo motors, 2, a liquid polymer cartridge, 3, a high-frequency, piezo-atomizing spray head, 4, a sheet-feeding system utilizing vacuum rollers, 5, a plane of lamination, 6, a scanning laser module, 7, an ultraviolet-C hot cathode lamp, 8, a tri-axial robotic gantry, 9, 10 and 11, an ultraviolet-B light-emitting diode array, 12, inner framework, 13

FIG. 2 is a perspective view of the invention depicting the following items:

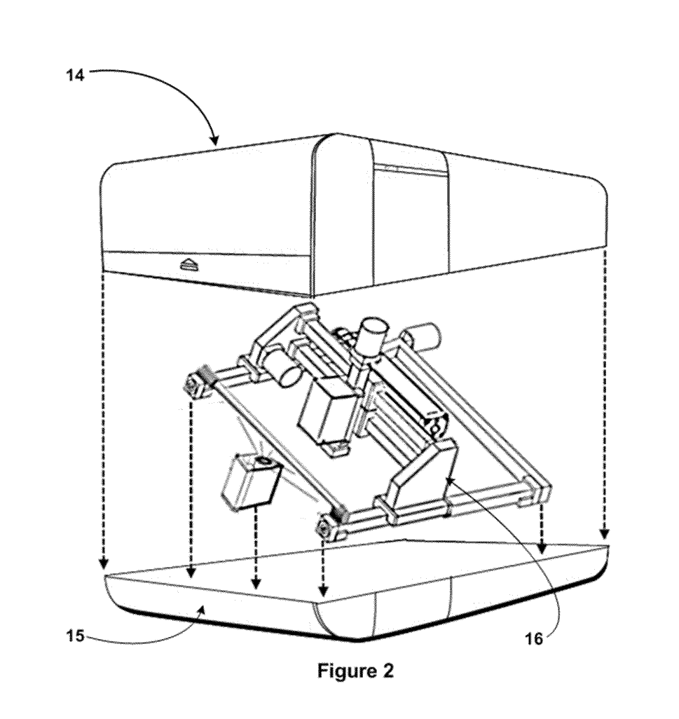

A user interface panel and machine enclosure top section, 14, the machine enclosure bottom section, 15, and showing the complete inner framework in relation to the enclosure, 16.

### DESCRIPTION OF THE SPECIFIC EMBODIMENTS

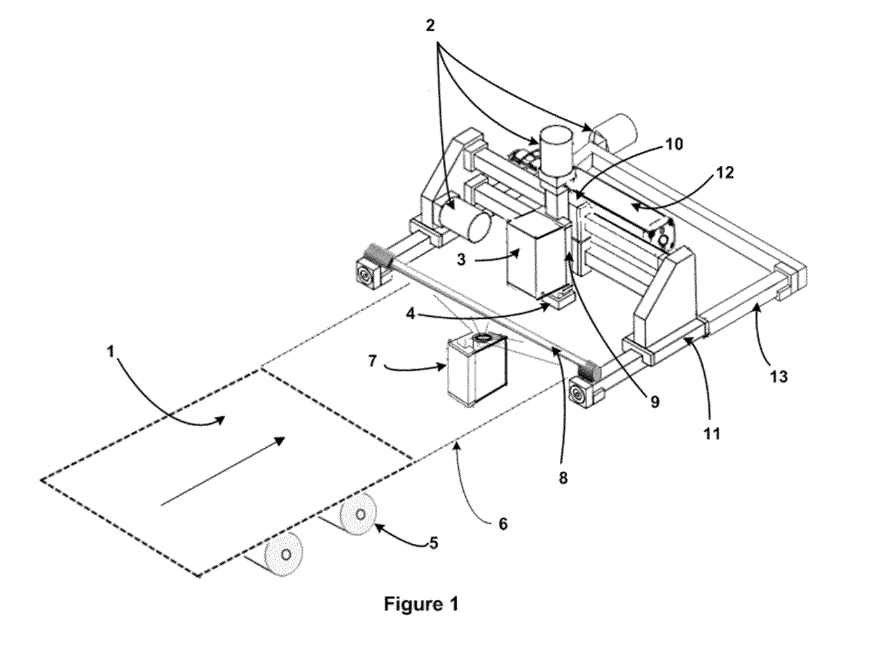

Our improved machine for the plastic lamination of paper or similar materials using the application of a liquid polymer coating and its curing via ultraviolet light sources consists of the following components and processes as shown in FIG. 1: A sheet-feeding system utilizing vacuum rollers, 5, for ‘grip-less’ transport of the substrate, 1, through the plane of lamination, 6, and exiting the machine into a paper tray (not shown).

When the material to be laminated enters the machine it is scanned by a laser module, 7, and the dimensions are sent to a central processing unit (not shown). The inner framework, 13, of the machine is an x-y-z axis, 11, 10, 9, robotic unit typical in industry for precise motion of a drill head, cutting tool or sprayer. The present invention utilizes micro-positioning piezo motors, 2, for precise control of a high-frequency piezo-atomizing ‘spray head’, 4. The spray head frequency and hence the spray width and droplet size are a function of the user-selected laminate thickness setting at the user interface panel located in the machine cover, 14. In addition to the previously described spray width and droplet size controls movement of the spray head nearer to or further from the substrate is controlled along the z axis to vary the thickness of the applied laminate, 9.

The liquid polymer is contained in a tank mounted on the z axis of the framework just above the spray head, 3. The polymer tank or cartridge is replaced when empty by the user with a refill polymer cartridge by sliding the empty cartridge off and sliding the refill cartridge into place. The material to be laminated is transported on center within the framework, 6. A low-energy ultraviolet lamp (hot-cathode, UV-C) is activated, 8. The UV-C lamp creates an oxygen reduction reaction (ORR) by ionizing the dissolved oxygen present in the liquid polymer, 3. Oxygen reduction in the liquid polymer promotes cross-linking of the polymer chains increasing the viscosity of the coating at the point of deposition to the substrate by the spray head, 4.

The spray head moves in a precise pattern under computer logic control along the x and y planes as it dispenses the liquid polymer to the substrate, 11, and 10. When the substrate material is coated the UV-C lamp is extinguished and the ultraviolet light-emitting diode (LED) array is activated (UV-B), 12. The ultraviolet-B spectrum, by its action on photo-initiators within the liquid polymer, cures the liquid coating into a hard, clear, tack-free coating as the LED array, 12, moves along the x axis, 11. The LED array is mounted to the y axis cross member in a fixed position in proximity to the substrate. It moves at a speed rate under computer logic control across the coated material until full curing is achieved. The finished product is then transported to a paper tray (not shown). For double-sided coating, a single-side laminated piece is re-run through the machine with the uncoated side facing up.

The machine, 16, is enclosed, 14, 15, and designed for desktop use.

The present invention operates without the need for inventory of multiple pouch sizes or rolls of film laminate. The only laminate inventory required is a refill cartridge of liquid polymer, 3. The liquid polymer cartridge is easy to replace by opening a cover in the machine enclosure, 14, removing the spent cartridge and sliding the new cartridge into place, 3. The operator places paper product or similar material into a feeder tray, 1, selects the desired laminate thickness and presses a start button. The material to be laminated is drawn into the machine where it automatically centers in the scanner bed/spray area, 6. Once in place the paper is scanned by a laser, 7, the data from the scan is sent to the machines' central processing unit (CPU), an automation-type control module. The paper is moved to the scanner bed/spray area via non-gripping vacuum rollers, 5. The use of vacuum rollers as opposed to standard rollers is important to the process; the substrate transported without the possibility of jamming or marring of the finished product. The digitally controlled applicator/spray head, 4, applies the liquid polymer in precisely-sized droplets per the thickness selected by the operator and only to the paper size without over-spraying the laminate. Our laminate coating is a precise blend of 100% solids liquid polymer and photo-initiators, both commercially available chemical products. The viscosity is within a range that will allow even deposition to the substrate without excessive misting or over-spray. A ‘pre-curing’ UV-C lamp, 8, is unique to the present invention and an essential element. The ionization of dissolved oxygen within the polymer promotes cross-linking of the polymer chains at the point of application, 4. This allows the liquid polymer to be of a relatively low viscosity, good for atomization by the spray head, but low-viscosity liquids tend to absorb too easily into a fibrous substrate such as paper or cardboard. Pre-curing by the UV-C lamp, 8, quickly increases the viscosity of the liquid polymer reducing absorption by the substrate. Enough of a bond is formed to the surface micro-fibers of the substrate, 1, for the adhesion of the polymer to the substrate. The spray head, 4, moves over the substrate precisely applying the coating to the edges of the piece (the dimensions of which were scanned into the CPU) traveling along the x and y axis, 11 and 10, driven by the piezo-servo motors, 2. An LED lamp array in the UV-B spectrum, 12, has the properties of low heat, low energy consumption and long life, moves over the coated substrate curing the liquid polymer to a hard, clear, protective lamination. Based on the lamination thickness set by the user the CPU calibrates exposure time needed to cure and scales the speed of the LED lamp array along the x axis, 11, for perfect exposure. There is no trimming needed to the finished laminated product since the machine only coats to the edges of the substrate unlike pouch or roll-film laminating machines. After the curing cycle is complete the finished piece is conveyed to a paper tray typical of printers and copiers. Key features of the present invention are typically found in various industrial and commercial equipment and products. The inventor has discovered that by combining existing technologies (OEM components) it was possible to create a unique machine for the stated purposes and utility functions. The precise chemical composition of the liquid polymer is a trade secret. Our plastic laminating machine offers ease-of-use by the operator, reduction in cost of materials (lamination), reduction of the need for trimming after lamination and offering choice of single-sided or double-sided lamination have not appeared in the marketplace until the present invention.

The key elements that make this invention unique, functional and economical are: a liquid polymer versus roll-plastic laminate or pouch plastic, automatic sensing of the paper/sheet size, operator-selectable laminate thickness, laminate curing via energy-saving, low-energy and low-heat ultra-violet lamps, touch-less (of the coated side of material) conveyance through the machine, single or double-sided laminating, no volatile organic compounds or odors emitted.

1. Sheet material laminating machine comprising laminating means for applying a clear plastic coating to at least one surface of a sheet to be laminated. The machine is compact in design for use as a desktop or tabletop laminator. The machine contains conveying means for positively driving a sheet such as aforesaid along a predetermined longitudinal path through said plane of lamination. Said conveying means also acts to stop and hold the sheet as the sheet is centered in the laminating area. The sheet is scanned by a laser connected to a central processing unit which determines the exact dimensions of the sheet. The dimensional data sets the parameters for a robotic spray head to precisely coat the sheet with liquid laminate without overspray. The conveying means utilizes a vacuum-holding technique generally know in the industry to prevent damage to the material and allowing the user to laminate sheets of varying thicknesses. Upon finishing the lamination cycle the conveying means moves the laminated sheet out of the machine to a paper-holding tray.

2. Sheet material laminating machine as set forth in claim 1 where said conveyor assembly comprises a series of vacuum rollers in a lateral assembly within the machine enclosure and located under the framework.

3. Sheet material laminating machine as set forth in claim 1 wherein said machine includes means for adjusting the desired thickness of the laminate through a user interface panel located in the machine's enclosure top.

4. Sheet material laminating machine as set forth in claim 1 including automatic robotic control of the path of the spray head along x, y and z axis and the movement of the ultraviolet-B lamp array over the sheet for curing.

5. Sheet material laminating machine as set forth in claim 1 wherein said laminating comprises a liquid polymer having a kinematic viscosity in the range of 10 to centistokes and dispersed from a piezo-type spray head to the exact dimensions of the sheet.

6. Sheet material laminating machine as set forth in claim 5 wherein said spray head is of a piezo-type design operating at frequencies in the range of 10 to 200 kHz and controlled via digital electronic control.

7. Sheet material laminating means as set forth in claim 6 wherein said spray head comprises a piezo-type means of deposition to the sheet and is fed liquid polymer contained in a replaceable cartridge. Said cartridge is mounted just above the spray head and is ducted to the spray head through a stationary tube to which the liquid polymer cartridge forms a seal upon insertion.

8. Sheet material laminating machine as set forth in claim 1 wherein said laminating means comprises manifold means movement of the spray head along three axis' for directing a spray of liquid laminate onto the sheet. Said paths are an x, a y and a z axis for movement of the spray head longitudinally, laterally and vertically.

9. Sheet material laminating machine as set forth in claim 8 wherein said laminating apparatus includes piezo motors for the precision movement of said spray head along the x, y and z axis'. The positioning of the spray head and therefore control of the piezo motors is by digital servo-motor control through a central processing unit. The spray head's motion is sweeping in character similar to that of inkjet or bubble-jet printers know in the art with the vertical motion of the spray head for spray width and laminate thickness moderation.

10. Sheet material laminating machine as set forth in claim 9 wherein said driving means includes servo-motor type control through the central processing unit. The data for adjustment of the spray head path is received from the scanning laser as set forth in claim 1.

11. Sheet material laminating machine as set forth in claim 9 wherein said motor-driving means includes movement of the spray head on a z axis; this movement adjusts the closeness of the spray head to the sheet to vary the thickness of the laminate coating in coordination with the sheet material laminating machine set forth in claim 6 wherein the frequency of the spray head changes the droplet size and flow of liquid polymer and based on user settings at the interface panel.

12. Sheet material laminating machine as set forth in claim 2 wherein said machine includes an enclosure containing said laminating means includes a vacuum producing means for the operation of said vacuum rollers as a means of sheet conveyance.

13. Sheet material laminating machine as set forth in claim 1 wherein said laminating means includes methods of curing the laminate via ultraviolet light sources. The light sources include an initial ‘pre-curing’ using ultraviolet-C light for the removal of dissolved oxygen (DO) from the low-viscosity liquid polymer causing the promotion of cross linking of the polymer chains. A second light source in the ultraviolet-B spectrum finishes the curing process. The curing process finishing stage is aided by the liquid polymer blend containing a percentage of photo-initiators typical of the printing industry.

14. Sheet material laminating machine as set forth in claim 13 wherein said ‘pre-curing’ initiates the curing process wherein the ultraviolet-C light ionizes the oxygen molecules causing them to be released from the polymer solution in the form of O₃. The release of oxygen from the polymer is sufficient to activate the cross-linking of polymer chains, the precursor to full curing. The pre-curing process increases the viscosity thereby reducing the absorption potential of the substrate. Excess absorption of the liquid polymer by the substrate may lead to wetting of the sheet material depending on the absorption/adsorption characteristics of the material.

15. Sheet material laminating machine comprising a housing having an upper part and a lower part cooperating to define a chamber and an inlet opening congruent with the inner framework and said chamber proffering a means of conveyance of the sheet material into the machine and moving same along a predetermined path through said inlet opening into said chamber and along said path from said inlet opening to and through said outlet opening. Said conveying means engages the lower surface of the sheet material with vacuum as the sheet material is advanced into position under the spray head thereby exposing the upper surface of the sheet material to the spray head. The laminating means enclosed within said chamber dispenses liquid laminate along the axis as put forth in claim 9.

16. Sheet material laminating machine as set forth in claim 15 wherein said laminating apparatus includes two light sources as a means of curing the liquid laminate into a hard, clear, protective surface on the sheet material. The upper surface of the sheet after it is conveyed along said path relative to said laminating means and positioned in the conveyance path on center within the inner framework the sheet is laser scanned as set forth in claim 1. The sheet-coating process and lighting of the pre-curing lamp take place concurrently. Upon fully coating the sheet with laminate the laminating apparatus lights the LED lamp array and the UVB curing is process takes place as set forth in claims 4 and 13. At the end of the UVB curing process the sheet is conveyed out of the enclosure as set forth in claim 15. This means of conveyance of the finished product being inherently touch-less virtually eliminates the potential for marring of the sheet or jamming by the sheet within the machine as may occur in machines employing a conventional grip-type roller system.

17. Sheet material laminating machine as set forth in claim 15 wherein said laminating means includes ultraviolet light sources such light sources are of low-energy design for energy conservation, the elimination of the machine as a source of heat in enclosed office spaces and increased lifespan of the light elements for low maintenance and reduced lifetime cost to the user.

18. Sheet material laminating machine using a liquid polymer as the laminate material as set forth in claim 1 having the properties of 100% solids and very low or no volatile organic compounds emitted and meeting indoor air quality standards for use in office space or other indoor enclosed area without user concerns of odor or off-gassing by the liquid polymer blend.

19. Sheet material laminating machine as set forth in claim 18 wherein the means of laminating includes a liquid polymer for deposition to a fibrous substrate material, typically paper or cardboard, the liquid polymer is of such consistency for the fast and even dispersal from the piezo spray head to the sheet without the spray head clogging, drying or limiting the flow of laminate in any way therefore eliminating the need for cleaning or periodic maintenance of the spray head by the user/operator.

20. Sheet material laminating machine comprising laminating means for ease of operation through the utilization of a liquid polymer cartridge as put forth in claim 7. Said cartridge shall provide the user with a convenient means of handling the laminate and the replacement of empty laminate cartridges. An access cover located in the top of the machine enclosure exposes the x axis where the cartridge is located. The empty cartridge is slipped out and the refill cartridge is slipped into place just above the spray head.

21. Sheet material laminating machine as set forth in claim 20 wherein said liquid polymer cartridge conveys the liquid polymer to the spray head. The liquid polymer cartridge has inherent venting for maintaining constant air pressure within the cartridge to sustain a constant and even flow of the liquid polymer laminate to the spray head. Additionally the vent compensates for air density at the machine elevation above sea level.

22. Sheet material laminating machine using a liquid polymer as the laminate material as set forth in claim 15 having the properties of 100% solids and very low or no volatile organic compounds emitted and meeting indoor air quality standards for use in office space or other indoor enclosed area without user concerns of odor or off-gassing by the liquid polymer blend.
